(19) United States
(12) Patent Application Publication
(10) Pub. No.: US 2008/0190064 A1
(43) Pub. Date: Aug. 14, 2008

(54) HURRICANE PANEL CLIP AND HOOK

(76) Inventors: Paul M. Craig, Hyannis, MA (US); Paul Bodensiek, Attleboro, MA (US)

Correspondence Address: CESARI AND MCKENNA, LLP, 88 BLACK FALCON AVENUE, BOSTON, MA, 02210, US

(21) Appl. No.: 12/015,202

(22) Filed: Jan. 16, 2008

Related U.S. Application Data
(60) Provisional application No. 60/889,372, filed on Feb. 12, 2007.

(51) Int. Cl. E04G 17/00; E04B 1/38; F16B 39/00

(52) U.S. Cl. 52/584.1; 411/166; 52/745.21

(57) ABSTRACT

A mounting for a protective panel to a structure that provides a block with an angled surface that forms a lateral groove facing downward that is attached to the top of the panel. A hook is attached to the structure with an upward facing angled surface that matches the downward facing lateral groove of the clip. The panel is raised to where the clip is above the hook and then pulled down so that the groove and the hook mate securing the panel to the structure. There is no need for an installer to climb to the top of the panel. The lower end of the panel may be secured to the structure by standard methods including screwing directly to the structure. The panel may also include lateral center supports to prevent the panels from bending during high winds.

### CROSS-REFERENCE TO RELATED APPLICATIONS

The present application claims the benefit of U.S. Provisional Patent Application Ser. No. 60/889,372, filed on Feb. 12, 2007, which provisional application is entitled: “Hurricane Panel Clip and Channel,” and is of common inventorship, and which provisional application is hereby incorporated herein by reference. The present application is also related to a co-filed application titled, Hurricane Panel Hook, of common ownership, inventorship, and which application is hereby incorporated herein by references.

### BACKGROUND OF THE INVENTION

1. Field of the Invention

The present invention relates to the protection of windows, doors and other vulnerable locations from damage due to wind and windborne debris.

2. Background Information

Hurricanes, typhoons and cyclones all have high winds that can destroy structures due to the force of the wind alone, but also due to debris that impact property and humans.

Some building codes now include a standard for storm panels that can withstand severe impacts by large wind driven items. Standard panels made from clear polycarbonate are often 14 inches wide, 0.110 inches thick, fabricated under one or more standards from the American Society for Testing and Material. Specifically the standards are: ASTM E1886, AASTM E1996, and ASTM E330 (cyclic and Static Wind Load and Impact Testing). Illustrative examples made in accordance with the present invention have been successfully tested by a qualified engineering laboratory and pass the afore mentioned ASTM specifications.

The '921 patent discloses use of corrugated polycarbonate panels mounted on aluminum or steel frames with thermal expansion room for the panels. The panels are overlapped, have key way slots, and are secured over a structure, such as a window, to be protected. Screws extending through the narrow portions of the key way slots are then tightened to secure the panels.

U.S. Pat. No. 5,457,921 ('921), which patent is hereby incorporated herein by reference, discusses the requirements to withstand high winds and debris impact.

In some prior art applications the top of the panel is not secured to the structure. The top may be simply inserted into the open “n” portion of an “h” header. With respect to high winds such a mounting of protective panels would span a vertical distance of about 48 inches before reinforcement was necessary. It would be advantageous if the vertical distance before a panel needed re-enforcing were increased.

The prior art use of corrugated polycarbonate panels still requires direct attachments at the top and bottom for maximum strength and spanned vertical distances. This means that an installer must reach the top of the panel and install the upper screws into the support structure each time the panels are installed.

U.S. Pat. No. 6,974,622 disclosed overlapped corrugated panels that have double re-enforced key ways. This patent is also incorporated herein by reference. This patent also discloses more detail on the specifics of windborne debris. Specifically, the panel should survive the impact of a missile weighing about 9.4 lbs (4.3 kgs), having a cross section impact area of about 5.25 sq. inches (34 square cm), and traveling at about 50 ft/sec (15.24 m/sec). However, the art disclosed in this patent also requires the installer to take the time to climb a ladder to reach and screw tight the panels.

The present invention addresses these and other limitations of the prior art.

### SUMMARY OF THE INVENTION

The present invention is directed to a hook attached to the structure being protected and a mating clip arranged at the top of a panel. The panel may be of the corrugated polycarbonate described above, but the panel may also be made of metal, wood or materials suitable for protecting the underlying structure from damage due to high winds and windborne debris and need not be of a corrugated design.

The hook is attached to the structure or to a header that is attached to the structure. The hook has an angled section that is meant to engage a groove with a matched angled surface in the clip. The groove with the angled surface may be entirely formed in the clip or formed by the clip and the panel. The clip is attached to the top of the panel by, in illustrative embodiments by a stud and nut or by a bolt through the panel into a tapped hole in the clip body, or by a bolt through the clip body and panel into a nut. The arrangement allows the panel to be pulled down so that the hook and clip are fully engaged. The bottom of the panel is secured to a track or other such fixture or the building structure by bolts or screws. The bottom of the panel is secured such that the top hook and clip will not become disengaged. This process has demonstrated as much a 60% less time to install hurricane panels while eliminating climbing of a ladder. In an emergency, e.g. an approaching hurricane, the reduced time and effort to install hurricane panels according to the present invention could be critical to protection of property, livelihood and personal safety. The present invention advantageously saves time and improves safety of installing such panels.

In one illustrative embodiment the panel may be attached by an installer with access only to the bottom of the panel. The top of the panel is inserted into the header above the hook. The panel is then straightened vertically and pulled down engaging the hook and clip. The bottom of the panel is then secured to the structure. A lateral center support may be used if the panel is long, and the panels may be overlapped to increase strength.

In some applications there may be several panels overlapping each other to some degree to provide extra strength.

In other preferred embodiments anti-rotation device may be used. A projection from the clip attached to the panel may extend into a mating recession, an aperture or through hole or slot in the panel to prevent the clip from rotating with respect to the panel. Other mechanisms may be used to prevent lateral motion of the clip with respect to the hook.

It will be appreciated by those skilled in the art that although the following Detailed Description will proceed with reference being made to illustrative embodiments, the drawings, and methods of use, the present invention is not intended to be limited to these embodiments and methods of use. Rather, the present invention is of broad scope and is intended to be defined as only set forth in the accompanying claims.

### BRIEF DESCRIPTION OF THE DRAWINGS

The invention description below refers to the accompanying drawings, of which:

FIG. 1A has one side cutaway views of the hook, attached to a structure, and the panel with attached clip and a two illustrating another method of attaching the clip to the panel, all three illustrating the operation of the hook and clip;

FIG. 1B illustrates two clips with anti-ration devices;

FIG. 1C illustrates an alternative clip design with anti-lateral motion device;

FIG. 1D illustrates an alternative clip design;

FIG. 1E is an alternative arrangement of a clip attached to a panel;

FIG. 2A is an assembly of a group of panels attached to a structure using an embodiment of the present invention; and

FIG. 2B is a perspective illustration of an individual panel.

### DETAILED DESCRIPTION OF AN ILLUSTRATIVE EMBODIMENT

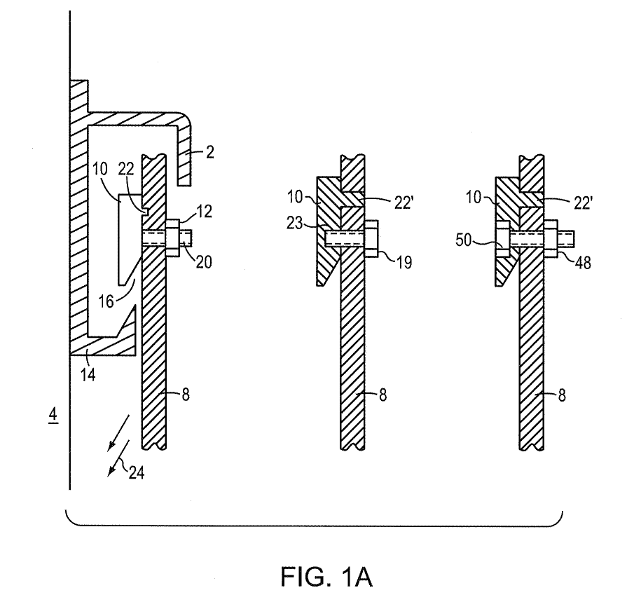

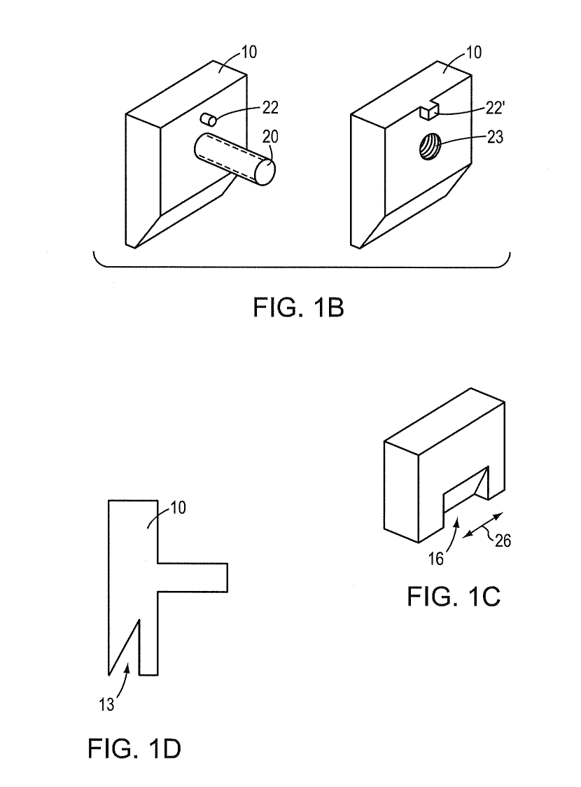

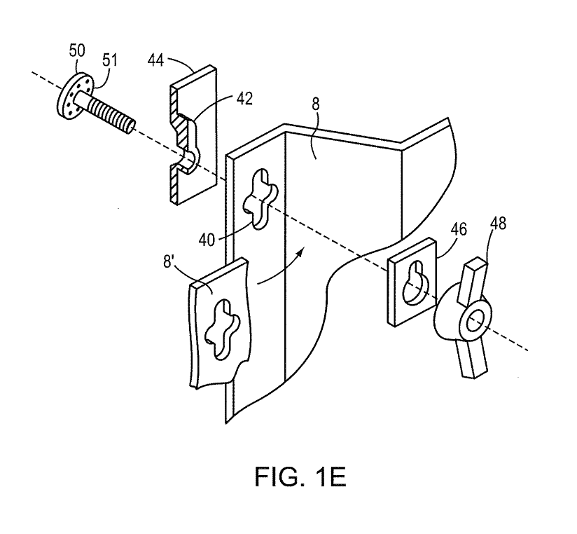

FIG. 1A is a cutaway view of a protective panel 8 with a clip 10 with a threaded extension 20 suitable for mating to a nut 12. The nut 12 secures the clip 10 to the corrugated panel 8. In this illustration an anti-rotation nib 22 extends from the clip 10 into a mating recess or notch just above where the threaded extension traverses the panel, but an aperture or through hole in the panel may replace the recess.

An “h” shaped header 2 is attached to the structure 4, in this case with a screw 6. Other screws (not shown) may be used to better secure the header to the structure 4. In one illustrative example, the “h” extends about 2.72″ from the structure and is made of 6063-T6 aluminum and may be of various lengths.

At the lower end of the header a hook 14 is formed that mates with a groove 16 formed between the clip 10 and the panel 8. In operation the clip is hoisted above the hook 14 and then pulled down in the directions of the arrow 24. The clip groove 16 is seated on the hook 14 so that when the panel is secured at the bottom the panel will not be able to un-attach itself from the hook.

FIG. 1A also shows use of a tapped hole 23 in the body of the clip and a bolt 19 that mates with the tapped hole that secures the clip to the panel. FIG. 1A also illustrates use of an anti-rotation device of an extension 22′ and a mating slot in the panel to accommodate the extension.

FIG. 1A also shows the use of a through bolt 50 passing through the clip 10 and panel 8 that mates with a nut 48 that secures the clip to the panel.

The hook may be integral with the header or it may be a separate piece attached to the header, in this illustrative embodiment, and the clip may be made of any material that provides the strength and the ability to be formed as shown in FIG. 1A. The materials may be virtually any metal, wood, plastic, composite and combinations thereof. The header, the clip and the hook (which may be a separate piece attached to the header) may all be of different materials. The hook may extend the length of the header or may be intermittent along the lateral dimension of the header.

FIG. 1B illustrates the clip 10, the stud 20 and the nib 22. An alternative extension 22′ is illustrated, and when used the panel 8 of FIG. 1A would be slotted to mate with the extension 22.′ A mating recession, aperture or through hole or slot in the panel may be used according to the anti-rotation device used. Other such anti-rotation devices, including multiple extensions and mating apertures in the panel may be used to advantage with the present invention.

In another illustrative embodiment as shown in FIG. 1C, the groove 16 may only extend for a width 26 designed to engage an intermittent hook feature is secured from lateral movement by the restricted groove. FIG. 1D illustrates a groove in the body of the clip without engaging the panel material.

FIG. 1E is yet another embodiment illustrating the present invention. Here the corrugated panel 8 has an aperture or keyhole 40, although a slot or rounded hole shaped aperture may be used to advantage in other applications. Here the keyhole 8 is shaped to accept a corresponding shaped protrusion 42 in a clip 44. The protrusion 42 is inserted through the keyhole 4, and a bolt 50 is inserted through the clip 44, the keyhole 40 and a mating washer 46. A wing nut 49 with a flat surface arranged to engage the washer when tightened secured the clip to the corrugated panel. A second panel 8′ with a matching keyhole may overlap with the first corrugated panel 8 and secured with the same bolt and wing nut. The bolt 50 may have an anti-rotation dimples 51 or a lock washer (not shown) may be used under the head of the bolt 50.

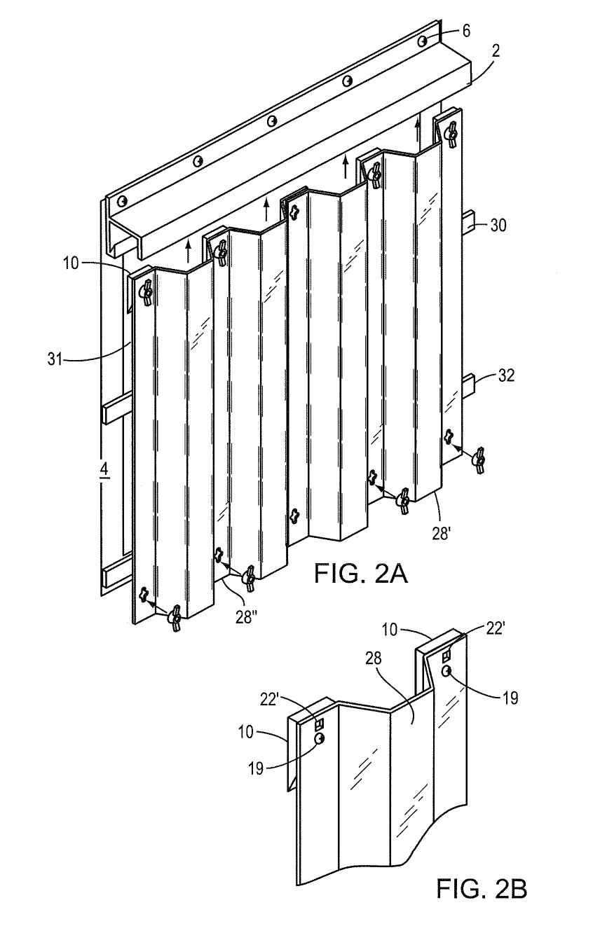

FIG. 2A shows a completed assembly where a corrugated panel assembly 28 composed of several individual panels 28′ and 28″ and others is secured to the header 2 by the clip 10 and hook 14 of FIG. 1A. A middle support 30 and a bottom sill support 32 may be used and attached to the structure 4 and the panel 28. Here the protective panels are located over a window 31.

FIG. 2B illustrates an individual panel 28 with slots 22′ and the head of bolts 19 that secures the panel to the clip 10, as shown in FIG. 1A.

Most often the panel 28 will be made of several overlapping panels, as known in the art, for increased strength. Translucent or transparent panels are often selected made of polycarbonate as discussed above, but the panels may be made of any suitable protective material, including word, metal, plastic or composites, etc. and need not be of a corrugated design.

At the bottom of the panel 28 keyholes are provided that match protruding studs built into a window sill support 32. A lock washer and wing nut may be used to secure the panel 28 after it has been pulled down to securely engage the clip 10 in the hook 14. In some illustrative embodiments the keyholes may be re-enforced.

As known to those skilled in the art, the panels may be loosely secured until the entire assembly is loosely attached to the sill support and the middle support, if used.

In other illustrative embodiments the bottom of the panel may be simply screwed to the structure, or permanently mounted fixtures known in the art, e.g., PANELMATES™, a Trademark of Pyramid Fasteners, see pyramidfasteners.com.

Although the disclosure herein is directed to securing protective panels to a structure, the present inventive clip and hook and method may be directed to attaching decorative, useful (say with shelves or pockets for storing items) or other types of panels.

It should be understood that above-described embodiments are being presented herein as examples and that many variations and alternatives thereof are possible. Accordingly, the present invention should be viewed broadly as being defined only as set forth in the hereinafter appended claims.

What is claimed is:

1. A clip and hook, used to secure a panel to a structure, the clip and hook comprising:
a clip comprising a body that is attached to the protective panel and provides a lateral groove;
a hook that is attached to the structure, wherein the hook has a shaped surface that mates with the lateral groove.

2. The clip and hook of claim 1 further comprising:
a header that overhangs the top of the panel and the clip and hook.

3. The clip and hook of claim 1 wherein the lateral groove includes an angled surface, and wherein the hook comprises a wedge shaped surface that matches and mates with the angled surface.

4. The clip and hook of claim 1 wherein the clip body comprises:
a threaded stud protruding from one surface of the clip body, wherein the stud traverses an aperture in the panel,
a nut that mates with the stud to secure the clip to the panel wherein the nut is mounted to the stud with the panel there between; and
an angled lateral surface along the lower edge of the clip body, wherein the angled surface forms a lateral groove along the lower edge of the clip body; and wherein the hook has a shaped surface that mates with the lateral groove.

5. The clip and hook of claim 1 wherein the body when in contact with the panel includes an anti-rotation device.

6. The clip and hook of claim 5 wherein the anti-rotation device comprises a attaching device that secures the panel to the clip body and a projection from the body that mates with an indentation in the panel, wherein a combination of the projection and the attaching device form two points of support to restrict rotation of the body with respect to the panel.

7. The clip and hook of claim 6 wherein the indentation in the panel is a slot through the panel

8. The clip and hook of claim 1 comprising:
the clip comprising a body with a tapped hole;
a bolt that mates with the tapped hole to secure the clip to the panel; and
an angled lateral surface along one edge of the body on the side of the block;
where the stud protrudes, wherein the angled surface and the surface of the panel form a lateral groove along the lower edge of the mounted block; and wherein the hook has a shaped surface that mates with the lateral groove.

9. The clip and hook of claim 1 comprising:
the clip comprising a body with a through hole and an anti-rotation protrusion;
a threaded bolt arranged to extend through a hole in the panel and the though hole in the clip; and
a nut that mates with the threaded bolt to secure the clip to the panel.

10. The clip and hook of claim 9 wherein the through hole extends through the anti-rotation protrusion, and wherein the anti-rotation protrusion has a keyhole shape.

11. The clip and hook of claim 10 wherein the anti-rotation protrusion comprises an attaching device that secures the panel to the clip body and a projection from the body that mates with an indentation in the panel, wherein a combination of the projection and the attaching device form two points of support to restrict rotation of the body with respect to the panel.

12. The clip and hook of claim 10 wherein the indentation in the panel is a slot through the panel

13. A method for securing of a protective panel to a structure, the method comprising the steps of:
laterally grooving a body and attaching the body to the protective panel, shaping a surface on a hook and attaching a hook to the structure, wherein the shaped surface mates with the lateral groove.

14. The method of claim 13 further comprising the step of:
attaching a header the structure wherein the header overhangs the top of the panel and the clip and hook.

15. The method of claim 13 further comprising the step of forming an angled surface as part of the lateral groove, and forming a wedge shaped surface in the hook where the wedge shaped surface matches and mates with the angled surface.

16. The method of claim 13 further comprising the step of:
threading a stud protruding from one surface of the clip body, wherein the stud traverses an aperture in the panel,
a nut that mates with the stud to secure the clip to the panel wherein the nut is mounted to the stud with the panel there between; and
an angled lateral surface along the lower edge of the clip body, wherein the angled surface forms a lateral groove along the lower edge of the clip body; and wherein the hook has a shaped surface that mates with the lateral groove.

17. The method of claim 13 further comprising the step of forming where the body contacts the body an anti-rotation device.

18. The method of claim 17 wherein the step of forming the anti-rotation device comprises the step of indenting the panel and projecting from the body an extension that mates with the indentation in the panel, wherein the mating of the projection and the indention forms two points of support to restrict rotation of the body with respect to the panel.

19. The method claim 18 wherein the step of indenting the panel compromises the step of piercing the panel with a hole or slot.

20. The method of claim 13 further comprising the steps of:
tapping a hole in the clip;
mating a bolt with the tapped hole wherein the panel lies between the tapped hole and the bolt head.

21. The method of claim 13 comprising:
piercing the body with an aperture and the panel each with a first aperture;
forming a second aperture in the panel, extending the body with an anti-rotation protrusion arranged to mate with the second aperture;
threading a bolt through the apertures in the panel and the clip, and
mating a nut that with the threaded bolt to secure the clip to the panel.
